(19) United States
(12) Patent Application Publication
(10) Pub. No.: US 2025/0104112 A1
(43) Pub. Date: Mar. 27, 2025

(54) System and Method for Identifying Digital Content Associated With Digital Components

(71) Applicant: Google LLC, Mountain View, CA (US)

(72) Inventors: Sarah Whitney, London (GB); Ranjith Lingamaneni, Short Hills, NJ (US); Derek Dunfield, New York, NY (US)

(21) Appl. No.: 18/543,547

(22) Filed: Dec. 18, 2023

Related U.S. Application Data
(60) Provisional application No. 63/540,505, filed on Sep. 26, 2023.

(51) Int. Cl. G06Q 30/0251

(52) U.S. Cl. CPC G06Q 30/0255; G06Q 30/0253

(57) ABSTRACT

The technology is generally directed to identifying and providing relevant digital content associated with digital components. The digital content may be identified based on a comparison of identifiers associated with the digital component to identifiers associated with the digital content. The digital component may include a content identifier, which may be used to determine one or more merchant identifiers. The merchant identifiers may be associated with brands, product types, or the like within the digital component. The merchant identifiers may be compared to content index identifiers. The content index identifiers may be used to identify the brands, product types, merchants, etc., of the digital content in the content index. When the merchant identifier matches a content index identifier, the digital content associated with the matching content index identifier may be identified as relevant digital content. The relevant digital content may be provided for output relative to the digital component.

### CROSS-REFERENCE TO RELATED APPLICATIONS

The present application claims the benefit of the filing date of U.S. Provisional Application No. 63/540,505, filed on Sep. 26, 2023, the disclosure of which is hereby incorporated herein by reference.

### BACKGROUND

Typically, after viewing or engaging with a digital component, users search for digital content relevant to the digital component. Having to search in another window or browser separate from the digital component leads to a fragmented user experience. Moreover, the user has to sort through the digital content within the search results to determine if the digital content is relevant to the digital component. Then, the user has to test to see if the digital content is usable. This may lead to dead ends, wasted time, and frustration for the user who is seeking valid and relevant digital content.

### BRIEF SUMMARY

The technology is generally directed to identifying and providing relevant digital content associated with digital components. The digital content may be identified based on a comparison of identifiers associated with the digital component to identifiers associated with the digital content. For example, the digital component may include and/or be associated with a content identifier. The content identifier may be used to determine one or more merchant identifiers. The merchant identifiers may be associated with brands, product types, or the like within the digital component. The merchant identifiers may be compared to content index identifiers. The content index identifiers may be used to identify the brands, product types, merchants, etc., of the digital content in the content index. When the merchant identifier matches a content index identifier, the digital content associated with the matching content index identifier may be identified as relevant digital content. The relevant digital content may be provided for output relative to the digital component.

One aspect of the technology is directed to a method, comprising receiving, by one or more processors, an indication of user engagement with a digital component, determining, by the one or more processors, a content identifier associated with the digital component, determining, by the one or more processors based on the content identifier, a merchant identifier, identifying, by the one or more processors based on the merchant identifier, relevant digital content, and providing for output, by the one or more processors and relative to the digital component, the relevant digital content.

The indication of user engagement may be at least one of a click or a view. The content identifier may correspond to a content provider of the digital component. The merchant identifier may correspond to a brand or product associated with the digital component. The content identifier may be the same as the merchant identifier. The content identifier may be different than the merchant identifier.

The method may further comprise generating, by the one or processors, a content index. Generating the content index may comprise at least one of automatically identifying, by the one or more processors scraping the internet, available digital content from content providers or merchants, or receiving, by the one or more processors from the content providers or merchants, the available digital content. When identifying the relevant digital content, the method may further comprise comparing, by the one or more processors, the merchant identifier with content index identifiers, wherein the available digital content includes an associated content index identifier and when the merchant identifier corresponds to a content index identifier, identifying, by the one or more processors, the digital content associated with the corresponding content index identifier as relevant digital content. The content index identifiers may correspond to merchant identifiers.

Another aspect of the disclosure is directed to a system comprising one or more processors. The one or more processors may be configured to receive an indication of user engagement with a digital component, determine a content identifier associated with the digital component, determine, based on the content identifier, a merchant identifier, identify, based on the merchant identifier, relevant digital content, and provide for output, relative to the digital component, the relevant digital content.

Yet another aspect of the disclosure is directed to one or more non-transitory computer-readable storage media encoding instructions that, when executed by one or more processors, cause the one or more processors to perform operations comprising receiving an indication of user engagement with a digital component, determining a content identifier associated with the digital component, determining, based on the content identifier, a merchant identifier, identifying, based on the merchant identifier, relevant digital content, and providing for output, relative to the digital component, the relevant digital content.

### BRIEF DESCRIPTION OF THE DRAWINGS

FIG. 1 is a screenshot illustrating example content, including relevant digital content associated with a digital component in accordance with aspects of the disclosure.

FIG. 2A is a screenshot illustrating an example digital component in accordance with aspects of the disclosure.

FIG. 2B is another screenshot illustrating example content provided in response to an input associated with a digital component in accordance with aspects of the disclosure.

FIG. 3 is a block diagram of an example system in accordance with aspects of the disclosure.

FIG. 4 is a flow diagram for an example method of providing relevant digital content in accordance with aspects of the disclosure.

### DETAILED DESCRIPTION

The technology is generally directed to automatically identifying digital content associated with digital components. The digital components may be associated with a content identifier. The content identifier may provide an identifier of the person or entity that submitted the digital component, what content is within the digital component, or the like. The content identifier may be used to identify a merchant identifier. For example, after receiving an indication that a user engaged with the digital component, a content identifier for the digital component may be identified. Based on the content identifier, a merchant identifier may be identified. The merchant identifier may correspond to a brand, category of product, specific product, or the like within the digital component. The merchant identifier may be used to identify relevant digital content. For example, the merchant identifier may be compared to content index identifiers associated with digital content in a content index. The content index identifiers may be, in some examples, similar to the merchant identifier in that the content index identifiers may correspond to merchants, brands, product types, specific products, or the like. When the merchant identifier corresponds to a content index identifier, the associated digital content may be identified as relevant digital content. The relevant digital content may be provided for output.

The digital components may be submitted to a publisher as part of a content submission. The digital component may be submitted by a content provider. The content provider may be, for example, a person, entity, business, etc. The content submission may include the digital component and data associated with the digital component. The data associated with the digital component may include, for example, the content provider, an identification of a brand or product within the digital component, or the like. The publisher may provide the digital components for output on a website or mobile application.

According to some examples, user engagement with the digital component may be determined. User engagement may include, for example, an input corresponding to selection of the digital component, an identifier that the digital component has remained on a visible part of the display for a threshold period of time, or the like. After receiving an indication that the user has engaged with the digital component, a content identifier associated with the digital component may be determined. The content identifier may be, in some examples, determined based on the digital component and/or the content submission of the digital component. For example, the content identifier may be associated with the digital component. In another example, the content identifier may be associated with the content submission of the digital component. In yet another example, the content identifier may be associated with both the digital component and the content submission. The content identifier may be a hash, an alpha-numeric string, or the like that is used to identify the digital component and/or associated content submission.

The content identifier may be used to identify a merchant identifier. For example, the content submission may include additional data associated with the digital component. The additional data associated with the content submission may, for example, include the merchant identifier. The merchant identifier may correspond to the brands, products, etc., within the digital component. The content identifier may be used to identify the content submission associated with the digital component and, therefore, the merchant identifiers associated with the digital component.

The merchant identifier may be used to identify relevant digital content. The digital content may be associated with the brand, product, etc., within the digital content. The digital content may be, for example, an offer, promotional code, coupon, code, or the like.

According to some examples, the relevant digital content may be identified based on a content index. The content index may store digital content for brands, specific products, product types, or the like. The digital content may be identified by scraping the internet, receiving digital content from content providers, merchants, brands, etc., or the like. The merchant identifier may be compared to the content index identifiers associated with the digital content to identify relevant digital content. The content index identifiers may be, in some examples, substantially similar to merchant identifiers. For example, the content index identifiers may correspond to the brands, product types, specific products, or the like associated with the digital content. Relevant digital content may be digital content in which the brand, specific product, product type, etc., of the content index identifier of the digital content corresponds to the respective brand, specific product, product type, etc., of the merchant identifier of the digital component.

The relevant digital content may be provided for display relative to the digital component. By providing the relevant digital content relative to the digital component, computational efficiency may increase. For example, by providing relevant digital content for output relative to the digital component, processing power and network overhead may decrease by receiving fewer user inputs to search for relevant digital content. Further, processing power and network overhead is decreased due to the need for fewer client device and server interactions. The client device and server interactions may decrease as providing the relevant digital content negates the need for the user to perform separate, or additional, searches to identify relevant digital content.

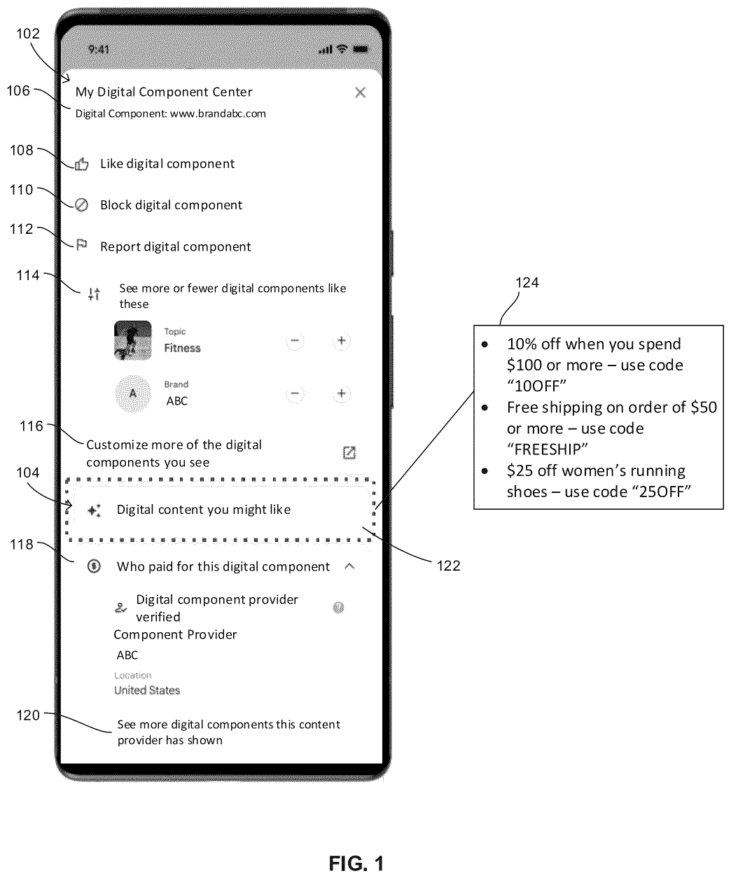

FIG. 1 is a screenshot of example output that is provided for display on a user device. The output may be provided in response to receiving an indication of user engagement with a digital component. The output may include information related to the digital component that the user engaged with. The digital component may be, for example, a video, image, advertisement, or the like. An indication of user engagement may include, for example, receiving an indication of a selection of the digital content, determining that a user has viewed the digital content, or the like. Determining that the user has viewed the digital content may include, for example, determining that the digital content has been provided for display on the user device for a threshold period of time.

As shown in FIG. 1, output 102 may include information related to the digital component. The output 102 may include, for example, relevant digital content 104. The relevant digital content 104 may be relevant to the digital component. For example, if the digital component is an advertisement, the relevant digital content may be offers, coupons, etc., relevant to the subject of the advertisement. The output 102 may be provided, automatically, in response to the user engagement with the digital component. In some examples, the output 102 may be provided in response to receiving an input corresponding to a selection to receiving information regarding the digital component.

The output 102 may include, for example, an indication of the website or mobile application associated with digital component 106. In some examples, output 102 may include inputs to like 108 the digital component, block 110 the digital component, or report 112 the digital component. Output 102 may include inputs 114 to see more or fewer of digital components having the same or similar topic, brand, etc. Output 102 may include an input 116 to further customize the digital components provided for output. Output 102 may include information 118 related to who paid for the digital component, whether the content provider was verified, who the content provider is, etc. In some examples, output 102 may include an input 120 to see more digital components the content provider has provided for display.

According to some examples, the output 102 may include the relevant digital content 104. The relevant digital content 104 may appear as part of output 102. In some examples, output 102 may include an input 122 associated with the relevant digital content 104 which, when an input corresponding to the selection of input 122 is received, may cause the relevant digital content 124 to appear. The relevant digital content 124 may appear as a pop-up, as shown, as a drop-down, as an overlay, or the like. The relevant digital content 124 may include text, images, or the like identifying the offers relevant to the digital component. For example, the relevant digital content 124 may be offers related to the merchant, brand, product type, topic, etc., within the digital component the user engaged with.

The relevant digital content 104 may be identified after receiving an indication that the user has engaged with the digital component. For example, in response to receiving an indication that the user has engaged with the digital component, the content identifier for the digital component may be determined. The content identifier may be associated with the digital component. For example, when a content provider submits a digital content submission to a publisher, the digital content submission may include the content identifier. In some examples, the content identifier may be associated with the digital component after the publisher receives the digital content submission. The content provider may be the person, entity, or the like that provided the digital component to the publisher for output. The publisher may be, for example, a website or a mobile application configured to provide content, such as digital content, digital components, or the like, as output.

The content identifier may be associated with one or more merchant identifiers. The merchant identifier may be a hash, an alpha-numeric string, or the like that is used to identify the merchants, or brands, within the digital content. The content identifier may be used to identify merchant identifiers. The merchant identifiers may be used to identify relevant digital content by comparing the merchant identifier to content index identifiers in a content index. The content index may store digital content for merchants, brands, specific products, product types, or the like. The digital content may be received directly from content providers, merchants, etc. In some examples, the digital content may be identified by scraping the internet. The digital content may, in some examples, include offers, coupon codes, promotional codes, etc. The digital content in the content index may be associated with content index identifiers. In some examples, the content index identifiers correspond to merchant identifiers. The content index identifiers of the digital content in the content index may be compared to the merchant identifiers associated with the digital component. When the merchant identifier matches the content index identifier, the digital content associated with the matching content index identifier may be identified as relevant digital content. The relevant digital content may be provided for output as part of relevant digital content 104.

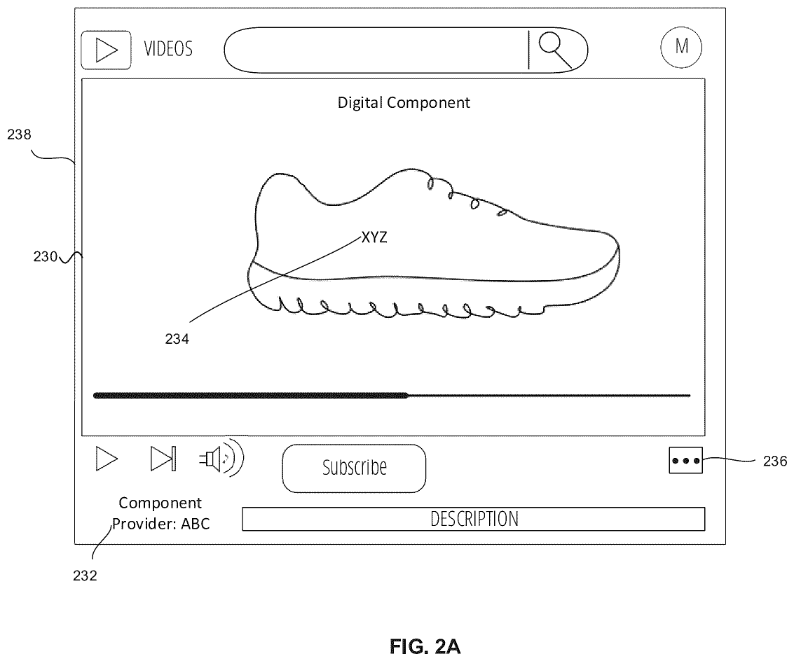

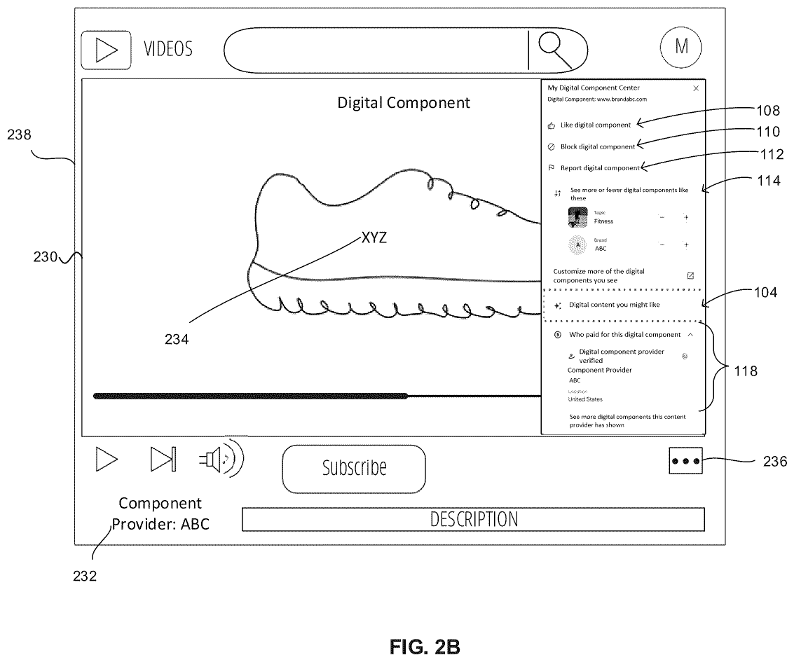

FIG. 2A illustrates an example digital component 230 being output on a display device. The digital component 230 may be provided for output to a user by a publisher. As shown, the digital component 230 is a digital video component for a retail store selling shoes. In some examples, the digital component 230 may be a video advertisement for the retail store selling shoes.

The digital component 230 may be part of a digital content submission. The digital content submission may be submitted to the publisher by a content provider 232. The digital content submission may include the digital component 230 and data associated with the digital component. The data associated with the digital component may include a description of the digital component, a topic of the digital component, a category of the product, a specific product, a merchant, a brand, etc., associated with the digital component, or the like. The digital content submission may include, for example, a content identifier. In some examples, the content identifier may be associated with the digital content submission after the publisher receives the submission.

According to some examples, the merchant, brand, product category, specific product, etc., (collectively “merchant”) with the digital component 230 may be associated with a merchant identifier. The merchant identifier may, in some examples, be included as part of the digital content submission. In some examples, such as when the merchant identifier is not included in the digital content submission, the merchant identifier may be determined by comparing the merchant or brand in the digital content to an index of merchant identifiers. The merchant identifier may be associated with the content identifier such that when the content identifier is determined, the associated merchant identifier can also be determined.

In some examples, more than one merchant identifier may be associated with the content identifier. For example, the digital component may include a plurality of merchants. Each merchant within the digital content may have a distinct merchant identifier. Each distinct merchant identifier for each merchant within the digital content may be associated with the content identifier for the digital content.

In some examples, the information associated with the digital component 230 may be determined based on the digital component 230. For example, one or more machine learning (“ML”) models may be trained to extract information associated with the digital component 230. The ML models may be trained to extract, for example, the merchant(s) within the digital component.

The system may, in some examples, receive an indication of user engagement with the digital component 230. The indication of user engagement may be, in some examples, receiving an input corresponding to the selection of the digital component 230. In some examples, the indication of user engagement may be, for example, determining the user has viewed the digital component 230. Viewing the digital component 230 may include, for example, watching the digital component 230 when the digital component 230 is a video. In some examples, viewing the digital component 230 may include the digital component remaining on the viewable portion of the display for a threshold period of time.

In response to receiving an indication of user engagement, relevant digital content may be identified. The relevant digital content may be, for example, digital content relevant to the digital component 230, the content provider 232, the merchant 234 within the component 230, the product category, the specific product, or the like.

The relevant digital content may be determined by determining the content identifier associated with the digital component 230. The content identifier may be identified based on the digital component 230. For example, by identifying the digital component 230 provided for output, the system may determine the content identifier associated with the digital component 230.

The content identifier may be used to determine one or more merchant identifiers. As discussed above and herein, the merchant identifiers may be provided as part of the digital content submission and/or automatically identified based on the digital component 230. The merchant identifiers may be the same as the content identifier. In some examples, the merchant identifiers may be different than the content identifier. The merchant identifiers may be, for example, a hash, an alpha-numeric string, or the like that identifies the merchant, brand, product category, specific product, etc., within the digital content.

The merchant identifiers may be used to identify relevant digital content. For example, after a content identifier is identified, the merchant identifiers associated with the content identifier may be identified. The merchant identifiers may, in some examples, be compared to merchant identifiers of digital content within a content index. In examples where the merchant identifier associated with the digital component and/or content identifier corresponds to the merchant identifier in the content index, the digital content may be identified as relevant digital content.

In some examples, the digital content identified as relevant digital content may be verified. Verification of digital content may include, for example, confirming that the merchant, brand, category of product, specific product, etc., of the digital content matches the corresponding merchant, brand, category of product, specific product, etc., of the digital component. The verification process may ensure that the relevant digital content provided for output corresponds to the merchant, brand, category of product, specific product, etc., of the digital component. This may prevent unnecessary, irrelevant, and/or unwanted digital content from being provided for output. By preventing unwanted digital content from being provided for output, computational efficiency may be increased by decreasing the processing power and network overhead required to identify and provide subsequent digital content to replace the originally provided digital content.

According to some examples, the display device 238 may include an input 236. The input 236 may be to learn more about the digital component 230, access additional digital content associated with the digital component, or the like. According to some examples, the display device 238 may be configured to receive an input corresponding to the selection of input 236.

FIG. 2B illustrates an example output on a display device in response to receiving a selection of input 236. For example, in response to receiving an input corresponding to the selection of input 236, an overlay 240 may be provided for output relative to the digital component 230. The overlay 240 may include, for example, one or more inputs related to the digital component 230. For example, the overlay 240 may include inputs 241-246 to customize the digital components that are provided for output. For example, input 242 may allow a user to “like” the digital component 230, input 243 may allow a user to block the digital component 230, input 244 may allow a user to report the digital component 230, and input 245, 246 may allow the user to see more or fewer digital components similar to the topic or brand shown in digital component 230.

Overlay 240 may include information 250 indicating who paid for the digital component 230. The information 250 may include an indication as to whether the digital component provider has been verified, who the component provider is, the associated location, etc.

Overlay 240 may include an input 248. The input 248 may be to access digital content. The digital content may be, for example, relevant digital content identified based on the digital component 230. For example, the system may identify a content identifier associated with the digital component 230. The content identifier may be used to identify merchant identifiers. The merchant identifiers may be identifiers associated with the brand, e.g., “XYZ”, product type, e.g., “sneakers,” or the like. The merchant identifiers may be compared to content index identifiers in a content index to identify relevant digital content. The relevant digital content may be, for example, offers, promotional codes, coupon codes, or for the brands, merchants, etc., associated with the digital component 230. In response to a selection on input 248, the relevant digital content may be provided for display as part of overlay 240, as a pop-up, as an additional overlay, or the like.

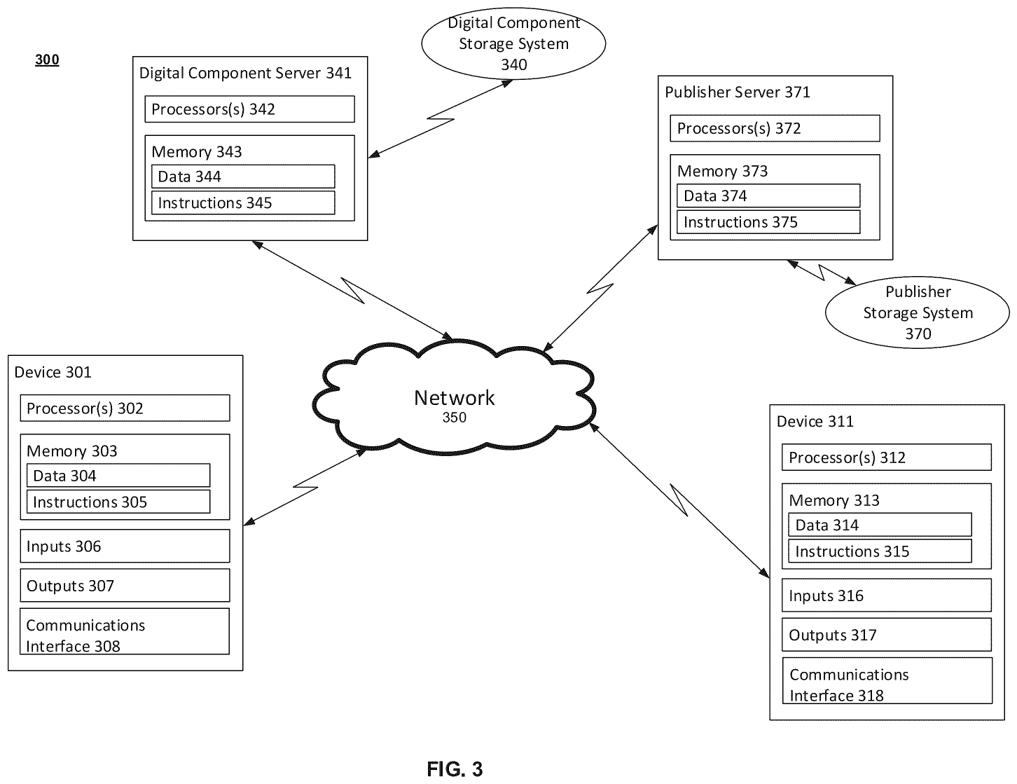

FIG. 3 illustrates an example system in which the features described above and herein may be implemented. It should not be considered as limiting the scope of the disclosure or usefulness of the features described herein. In this example, system 300 includes devices 301, 311, digital component server 341, digital component server storage system 340, publisher server 371, publisher storage system 370, and network 350. For purposes of clarity, devices 301, 311 will be described with respect to device 301. However, it should be understood that device 311 may include the same or similar components and may function in substantially the same way.

Device 301 may be a user device. Device 301 may include one or more processors 302, memory 303, data 304 and instructions 305. Device 301 may also include inputs 306, outputs 307, and a communications interface 308. The devices 301 may be, for example, a smart phone, tablet, laptop, smart watch, AR/VR headset, smart helmet, home assistant, etc.

Memory 303 of device 301 may store information that is accessible by processor 302. Memory 303 may also include data that can be retrieved, manipulated or stored by the processor 302. The memory 303 may be of any non-transitory type capable of storing information accessible by the processor 302, including a non-transitory computer-readable medium, or other medium that stores data that may be read with the aid of an electronic device, such as a hard-drive, memory card, read-only memory (ROM), random access memory (RAM), optical disks, as well as other write-capable and read-only memories. Memory 303 may store information that is accessible by the processors 302, including instructions 305 that may be executed by processors 302, and data 304.

Data 304 may be retrieved, stored or modified by processors 302 in accordance with instructions 305. For instance, although the present disclosure is not limited by a particular data structure, the data 304 may be stored in computer registers, in a relational database as a table having a plurality of different fields and records, XML documents, or flat files. The data 304 may also be formatted in a computer-readable format such as, but not limited to, binary values, ASCII or Unicode. By further way of example only, the data 304 may comprise information sufficient to identify the relevant information, such as numbers, descriptive text, proprietary codes, pointers, references to data stored in other memories (including other network locations) or information that is used by a function to calculate the relevant data.

The instructions 305 can be any set of instructions to be executed directly, such as machine code, or indirectly, such as scripts, by the processor 302. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 302 may include any conventional processors, such as a commercially available CPU or microprocessor. Alternatively, the processor can be a dedicated component such as an ASIC or other hardware-based processor. Although not necessary, device 301 may include specialized hardware components to perform specific computing functions faster or more efficiently.

Although FIG. 3 functionally illustrates the processor, memory, and other elements of device 301 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of device 301. Accordingly, references to a processor or device will be understood to include references to a collection of processors or devices or memories that may or may not operate in parallel.

The inputs 306 may be, for example, a mouse, keyboard, touch-screen, microphone, camera, image capturing device, or any other type of input. The inputs may be configured to select input 236, as shown in FIGS. 2A and 2B.

Output 307 may be a display, such as a monitor having a screen, a touch-screen, a projector, or a television. The display 307 of the device 301 may electronically display information to a user via a graphical user interface (GUI) or other types of user interfaces. For example, display 307 may electronically display information associated with digital components received in response to receiving an input corresponding to the selection of input 236. In some examples, display 307 may electronically display one or more additional inputs available for selection. The additional inputs may provide access to additional information associated with the digital component, the digital content, or the like.

The devices 301 can be at various nodes of a network 350 and capable of directly and indirectly communicating with other nodes of network 350. Although two devices are depicted in FIG. 3, it should be appreciated that a typical system can include one or more computing devices, with each computing device being at a different node of network 350. The network 350 and intervening nodes described herein can be interconnected using various protocols and systems, such that the network can be part of the Internet, World Wide Web, specific intranets, wide area networks, or local networks. The network 350 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 300 may include one or more server computing devices, such as digital component server 341 and publisher server 371. The server computing devices may be, for example, a load balanced server farm, that exchanges information with different nodes of a network for the purpose of receiving, processing and transmitting the data to and from other computing devices. For instance, ad server 341 and publisher server 371 may be a web server that is capable of communicating with device 301 via the network 350. In addition, digital component server 341 and publisher server 371 may use network 350 to transmit and present information to a user of device 301. Digital component server 341 and publisher server 371 may include one or more processors 342, 372, memory 343, 373, data 344, 374, instructions 345, 375, etc. These components operate in the same or similar fashion as those described above with respect to device 301.

Digital component server 341 may manage content, such as digital components, and provide various services to the advertisers, publishers, and devices 301. According to some examples, digital component server 341 may receive content submissions from one or more content providers, such as merchants, advertisers, brands, or the like. The content submissions may include the digital component and data associated with the digital component. The data associated with the digital component may include, for example, the content provider, an identification of a brand or product within the digital component, or the like. The content submissions may be stored in the memory 343 of digital component server 341 and/or in digital component server storage system 340.

According to some examples, publisher server 371 may provide content for output on a first user device. For example, publisher server 371 may retrieve content from publisher storage system 370 to provide for output to the first user device. The publisher server 371 may transmit a content page or other presentation, representation, or characterization of the content to the requesting device 301. According to some examples, the content page may include, for example, one or more digital components. In some examples, publisher server 371 may transmit a request for digital components to digital component server 341. Digital component server 341 may facilitate the identification of relevant digital components for distribution to the publishers.

In response to the publisher server 371 and/or digital component server 341 receiving an indication of user engagement with the digital component provided for output, the digital component server 341 may identify relevant digital content. For example, the relevant digital content may be identified based on the content identifier associated with the selected digital component. The content identifier may be used to determine a merchant identifier. For example, the merchant identifier may correspond to a brand, product type, or specific product within the digital component. The merchant identifier may be used to identify relevant digital content.

Device 301 may present in a viewer, such as a browser, mobile application, or other content display system, the content including one or more of the digital components provided by the digital component server 341. The relevant digital content may be provided for display in response to receiving an input corresponding to a selection to access additional information associated with the digital component. The additional information may include, for example, the relevant digital content.

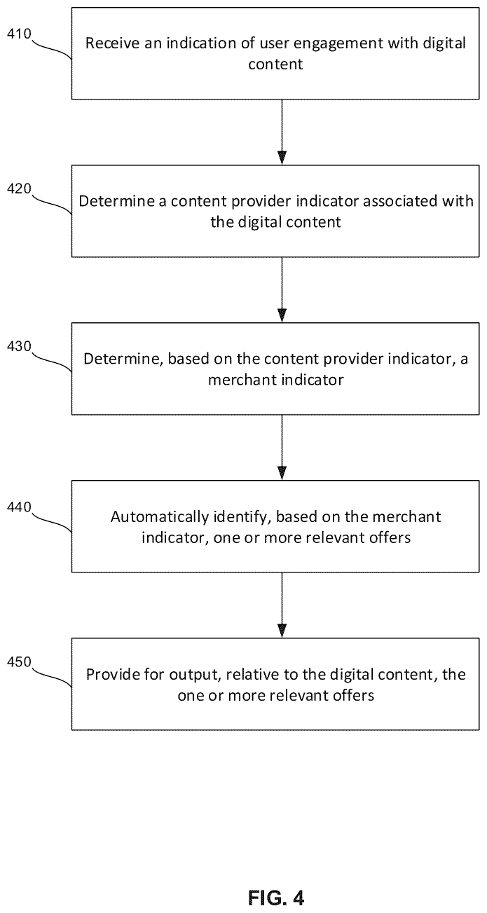

FIG. 4 illustrates an example method for providing relevant digital content associated with a digital component. The following operations do not have to be performed in the precise order described below. Rather, various operations can be handled in a different order or simultaneously, and operations may be added or omitted.

In block 410, an indication of user engagement with a digital component may be received. The indication of user engagement may be, for example, a click or a view. For example, the system may receive an input corresponding to the selection of the digital component. In some examples, the input may correspond to a selection to access additional information associated with the digital component. A view may include, for example, the digital component remaining on the visible part of the display of a user device for a threshold period of time.

In block 420, a content identifier associated with the digital component may be determined. The content identifier may correspond to a content provider of the digital component. The content provider of the digital component may be the provider who submitted the content submission to the publisher.

In block 430, a merchant identifier may be determined based on the content identifier. The merchant identifier may correspond to a brand or a product associated with the digital component. As an example, if the digital component is for brand “XYZ” athletic shoes, the merchant identifier may correspond to brand XYZ, product athletic shoes, or the like. In some examples, more than one merchant identifier may be identified.

According to some examples, the merchant identifier may correspond to the content identifier. For example, if the merchant identifier is for brand “XYZ” and the content provider and, therefore, the content identifier, is also brand “XYZ,” the merchant identifier is the same as the content identifier. In some examples, the merchant identifier is for brand “XYZ” but the content provider and, therefore, the content identifier is for provider “ABC.” In such an example, the merchant identifier is different than the content identifier.

In block 440, relevant digital content may be automatically identified based on the merchant identifier. Identifying the relevant digital content may include comparing the merchant identifier with content identifiers. For example, available digital content may include an associated content index identifier. When the merchant identifier corresponds to a content index identifier, the digital content associated with the corresponding content index identifier may be identified as relevant digital content.

The available digital content and associated content index identifier may be stored in a content index. The content index may be generated automatically by identifying available digital content from content providers or merchants. The digital content may be identified by scraping the internet. In some examples, generating the content index includes receiving the available digital content from the content providers or merchants. The identified and/or received available digital content may be stored in the content index. The available digital content may include an associated content index identifier. The content index identifier may correspond to a merchant, product type, specific product, etc., associated with the digital content. In some examples, the content index identifiers may substantially correspond to merchant identifiers. In some examples, the digital content may be a promotional offer, coupon code, one time use code, or the like.

According to some examples, the digital content identified as relevant digital content may be verified. Verification of digital content may include, for example, confirming that the merchant, brand, category of product, specific product, etc., of the digital content matches the corresponding merchant, brand, category of product, specific product, etc., of the digital component. In some examples, verification of the digital content may include confirmation that the digital content is valid and/or usable. For example, if the digital content is a promotional code, verification may include confirmation that the digital content has not expired.

In block 450, the relevant digital content may be provided for output relative to the digital component. For example, the relevant digital content may be provided as an overlay, pop-up, drop down, or the like relative to the digital component. In some examples, the relevant digital component may be provided for output in response to receiving an input corresponding to the selection to access information associated with the digital component.

Identifying relevant digital content in response to an indication of user engagement may increase the computational efficiency of the system. For example, identifying and providing relevant digital content in response to a user engagement with a digital component may decrease the number of inputs received by the system, thereby decreasing processing power and network overhead. In particular, a user may no longer have to separately and/or additionally search for relevant digital content associated with the digital component. Reducing the number of searches to identify and output relevant digital content reduces the number of inputs, processing power, and network overhead to access the digital content. Further, reducing the number of searches or inputs required by a user to identify the relevant digital content decreases the number of client device and server interactions to obtain the same information as automatically identifying the relevant digital content in response to a user interaction with the digital component. This, too, decreases the processing power and network overhead and increases the computational efficiency required to identify relevant digital content.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
providing for output, by one or more processors via a user interface, a digital component;
receiving, by the one or more processors, an indication of user engagement with the digital component;
determining, by the one or more processors in response to receiving the indication of the user engagement, a content identifier associated with the digital component;
determining, by the one or more processors based on the content identifier, a merchant identifier;
identifying, by the one or more processors based on the merchant identifier, relevant digital content; and
providing for output, by the one or more processors via the user interface and relative to the digital component, the relevant digital content.

2. The method of claim 1, wherein the indication of user engagement is at least one of a click or a view.

3. The method of claim 1, wherein the content identifier provides an indication of:
content within the digital component, or
a person, content provided, or entity that submitted the digital component.

4. The method of claim 1, wherein the merchant identifier provides an indication of a brand, category of product, type of product, or specific product within the digital component.

5. The method of claim 1, wherein:
the content identifier is the same as the merchant identifier, or
the content identifier is different than the merchant identifier.

6. (canceled)

7. The method of claim 1, further comprising:
generating, by the one or processors, a content index, wherein generating the content index comprises at least one of:
automatically identifying, by the one or more processors scraping the internet, available digital content from content providers or merchants, or
receiving, by the one or more processors from the content providers or merchants, the available digital content.

8. The method of claim 7, wherein when identifying the relevant digital content, the method further comprises:
comparing, by the one or more processors, the merchant identifier with content index identifiers, wherein the available digital content includes an associated content index identifier; and
when the merchant identifier corresponds to a content index identifier, identifying, by the one or more processors, the digital content associated with the corresponding content index identifier as relevant digital content.

9. The method of claim 8, wherein the content index identifiers correspond to merchant identifiers.

10. A system, comprising:
one or more processors, the one or more processors configured to:
provide for output, via a user interface, a digital component;
receive an indication of user engagement with the digital component;
determine, in response to receiving the indication of the user engagement, a content identifier associated with the digital component;
determine, based on the content identifier, a merchant identifier;
identify, based on the merchant identifier, relevant digital content; and
provide for output, via the user interface and relative to the digital component, the relevant digital content.

11. The system of claim 10, wherein the indication of user engagement is at least one of a click or a view.

12. The system of claim 10, wherein the content identifier provides an indication of:
content within the digital component, or
a person, content provided, or entity that submitted the digital component.

13. The system of claim 10, wherein the merchant identifier provides an indication of a brand, category of product, type of product, or specific product within the digital component.

14. The system of claim 10, wherein the content identifier is the same as the merchant identifier.

15. The system of claim 10, wherein the content identifier is different than the merchant identifier.

16. The system of claim 10, wherein the one or more processors are further configured to:
generate a content index, wherein generating the content index comprises at least one of:
automatically identifying, by scraping the internet, available digital content from content providers or merchants, or
receiving, from the content providers or merchants, the available digital content.

17. The system of claim 16, wherein when identifying the relevant digital content, the one or more processors are further configured to:
compare the merchant identifier with content index identifiers, wherein the available digital content includes an associated content index identifier; and
when the merchant identifier corresponds to a content index identifier, identify the digital content associated with the corresponding content index identifier as relevant digital content.

18. The system of claim 17, wherein the content index identifiers correspond to merchant identifiers.

19. One or more non-transitory computer-readable storage media encoding instructions that, when executed by one or more processors, cause the one or more processors to perform operations comprising:
providing for output, via a user interface, a digital component;
receiving an indication of user engagement with the digital component;
determining, in response to receiving the indication of the user engagement, a content identifier associated with the digital component;
determining, based on the content identifier, a merchant identifier;
identifying, based on the merchant identifier, relevant digital content; and
providing for output, via the user interface and relative to the digital component, the relevant digital content.

20. The one or more non-transitory computer-readable storage media of claim 19, wherein, when identifying the relevant digital content, the one or more processors perform operations comprising:
comparing, by the one or more processors, the merchant identifier with content index identifiers, wherein available digital content includes an associated content index identifier; and
when the merchant identifier corresponds to a content index identifier, identifying, by the one or more processors, the digital content associated with the corresponding content index identifier as relevant digital content.

21. The method of claim 4, wherein:
the relevant digital content comprises at least one of a promotional offer, coupon code, or offer, and
at least one of a brand, specific product, or product type of the relevant digital content corresponds to a brand, specific product, or product type of the merchant identifier of the digital component.
